(19) United States
(12) Patent Application Publication
(10) Pub. No.: US 2019/0110309 A1
(43) Pub. Date: Apr. 11, 2019

(54) DATA TRANSMISSION METHOD AND APPARATUS

(71) Applicant: HUAWEI TECHNOLOGIES CO., LTD., Shenzhen (CN)

(72) Inventors: Bin XU, Shanghai (CN); Xiaoqun HU, Shanghai (CN)

(73) Assignee: HUAWEI TECHNOLOGIES CO., LTD., Shenzhen (CN)

(21) Appl. No.: 16/193,289

(22) Filed: Nov. 16, 2018

Related U.S. Application Data
(63) Continuation of application No. PCT/CN2016/082388, filed on May 17, 2016.

(51) Int. Cl. H04W 72/12; H04L 5/00

(52) U.S. Cl. CPC H04W 72/1268; H04W 72/1273; H04L 5/0048; H04L 5/0055

(57) ABSTRACT

A data transmission method and apparatus are disclosed in the present invention. The method includes: determining whether there is to-be-scheduled user equipment in a first transmission time interval, where a frame structure used in the first transmission time interval includes a data scheduling area and a control information scheduling area; when it is determined that there is to-be-scheduled user equipment in the first transmission time interval, determining whether there is any idle resource in the control information scheduling area; and after it is determined that there is still an idle resource in the control information scheduling area, sending indication information to the to-be-scheduled user equipment, where the indication information is used to instruct the user equipment to send uplink data on an idle resource of the uplink control information scheduling area and/or obtain downlink data on an idle resource of the downlink control information scheduling area.

### CROSS-REFERENCE TO RELATED APPLICATIONS

This application is a continuation of International Application No. PCT/CN2016/082388, filed on May 17, 2016, the disclosure of which is hereby incorporated by reference in its entirety.

### TECHNICAL FIELD

The present invention relates to the communications field, and in particular, to a data transmission method and apparatus.

### BACKGROUND

In a time division duplex (TDD) standard of a wireless cellular communications system based on orthogonal frequency division multiplexing (OFDM), a base station usually schedules uplink/downlink data in a data scheduling area and schedules uplink/downlink control information in a control information scheduling area. This may cause a waste of resources of the control information scheduling area and lead to low data transmission efficiency.

### SUMMARY

In view of this, the present invention provides a data transmission method, so as to effectively utilize control channel resources.

According to a first aspect, a data transmission method is provided, and the method includes: determining whether there is to-be-scheduled user equipment in a first transmission time interval, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, and the downlink control information scheduling area is used to carry downlink control information; when it is determined that there is to-be-scheduled user equipment in the first transmission time interval, determining whether there is any idle resource in the control information scheduling area; and after it is determined that there is still an idle resource in the control information scheduling area, sending indication information to the to-be-scheduled user equipment, where the indication information is used to instruct the user equipment to send uplink data on an idle resource of the uplink control information scheduling area and/or obtain downlink data on an idle resource of the downlink control information scheduling area.

Using a remaining resource of the control information scheduling area for data transmission can effectively utilize control channel resources and improve data transmission efficiency.

With reference to the first aspect, in a first possible implementation of the first aspect, the data scheduling area is an uplink data scheduling area, and the determining whether there is any idle resource in the control information scheduling area includes: determining whether resources are insufficient in the uplink data scheduling area, and when it is determined that the resources are insufficient in the uplink data scheduling area, determining whether there is any idle resource in the uplink control information scheduling area.

With reference to some implementations of the foregoing first aspect, in a second possible implementation of the first aspect, the data scheduling area is a downlink data scheduling area, and the determining whether there is any idle resource in the control information scheduling area includes: determining whether resources are insufficient in the downlink data scheduling area, and when it is determined that the resources are insufficient in the downlink data scheduling area, determining whether there is any idle resource in the downlink control information scheduling area.

When resources of the data scheduling area are insufficient, using a remaining resource of the control information scheduling area for data transmission avoids a waste of control channel resources and improves data transmission efficiency.

With reference to some implementations of the foregoing first aspect, in a third possible implementation of the first aspect, the indication information includes identification information, and the identification information is used to identify that the downlink data is to be transmitted after the indication information.

The downlink data is transmitted after the indication information, so that the user equipment can obtain the downlink data through one blind detection.

Optionally, the indication information includes location indication information, and the location indication information is used to instruct the user equipment to send the uplink data at a first location of the idle resource of the uplink control information scheduling area and/or receive the downlink data at a second location of the idle resource of the downlink control information scheduling area.

With reference to some implementations of the foregoing first aspect, in a fourth possible implementation of the first aspect, the downlink control information scheduling area includes a physical downlink control channel PDCCH, and the PDCCH occupies three orthogonal frequency division multiplexing OFDM symbols of the frame structure.

With reference to some implementations of the foregoing first aspect, in a fifth possible implementation of the first aspect, the uplink control information scheduling area includes a physical uplink control channel PUCCH, and the PUCCH occupies three orthogonal frequency division multiplexing OFDM symbols of the frame structure.

Sufficient control channel resources are configured, so that control information transmission is no longer a bottleneck.

With reference to some implementations of the foregoing first aspect, in a sixth possible implementation of the first aspect, at least one of the following signaling is carried in the downlink control information scheduling area: a system message broadcast, a random access response, a paging message, and channel state information-reference signal CSI-RS.

Sending important signaling always in the downlink control information scheduling area can reduce an access delay of the user equipment.

According to a second aspect, a data transmission method is provided, and the method includes: receiving indication information sent by a base station in a first transmission time interval, where a frame structure used in the first transmission time interval includes a data scheduling area, an uplink control information scheduling area, and a downlink control information scheduling area, the data scheduling area is used to carry data, the uplink control information scheduling area is used to carry uplink control information, the downlink control information scheduling area is used to carry downlink control information, and the indication information is used to instruct user equipment to send to-be-transmitted uplink data on an idle resource of the uplink control information scheduling area and/or obtain to-be-transmitted downlink data on an idle resource of the downlink control information scheduling area; and according to the indication information, sending the uplink data on the idle resource of the uplink control information scheduling area and/or obtaining the downlink data on the idle resource of the downlink control information scheduling area.

Using a remaining resource of the control information scheduling area for data transmission can effectively utilize control channel resources and improve data transmission efficiency.

With reference to the second aspect, in a first possible implementation of the second aspect, the indication information includes identification information, and the identification information is used to identify that the downlink data is to be transmitted after the indication information, and the sending the uplink data on the idle resource of the uplink control information scheduling area and/or obtaining the downlink data on the idle resource of the downlink control information scheduling area includes: obtaining the downlink data after the indication information according to the identification information.

The identification information is added to the indication information, so that the user equipment can obtain the downlink data through one blind detection.

With reference to some implementations of the foregoing second aspect, in a second possible implementation of the second aspect, the indication information includes location indication information, and the location indication information is used to instruct the user equipment to send the uplink data at a first location of the idle resource of the uplink control information scheduling area and/or receive the downlink data at a second location of the idle resource of the downlink control information scheduling area; and the sending the uplink data on the idle resource of the uplink control information scheduling area and/or obtaining the downlink data on the idle resource of the downlink control information scheduling area includes: according to the indication information, sending the uplink data at the first location and/or receiving the downlink data at the second location.

According to a third aspect, a data transmission apparatus is provided, configured to execute the method in any one of the first aspect or the possible implementations of the first aspect. Specifically, the apparatus includes a unit configured to execute the method in any one of the first aspect or the possible implementations of the first aspect.

According to a fourth aspect, a data transmission apparatus is provided, configured to execute the method in any one of the second aspect or the possible implementations of the second aspect. Specifically, the apparatus includes a unit configured to execute the method in any one of the second aspect or the possible implementations of the second aspect.

According to a fifth aspect, an apparatus is provided, including a memory, a processor, a transceiver, and a bus system. The memory, the processor, and the transceiver are connected by using the bus system; the memory is configured to store an instruction; the processor is configured to execute the instruction stored in the memory, so as to control the transceiver to receive a signal or send a signal; and when the processor executes the instruction stored in the memory, the execution causes the processor to execute the method in any one of the first aspect or the possible implementations of the first aspect.

According to a sixth aspect, an apparatus is provided, including a memory, a processor, a transceiver, and a bus system. The memory, the processor, and the transceiver are connected by using the bus system; the memory is configured to store an instruction; the processor is configured to execute the instruction stored in the memory, so as to control the transceiver to receive a signal or send a signal; and when the processor executes the instruction stored in the memory, the execution causes the processor to execute the method in any one of the second aspect or the possible implementations of the second aspect.

According to a seventh aspect, a computer storage medium is provided, configured to store a computer software instruction used in the foregoing method, where the instruction includes a program designed for executing the foregoing aspects.

In the present invention, names of the base station and the user equipment do not constitute any limitation on the devices themselves, and in actual implementation, these devices may appear in another name. Devices with functions similar to those in the present invention fall within the scope of the claims of the present invention and equivalent technologies thereof.

These aspects or other aspects of the present invention are more concise and easy to understand in the following description of the embodiments.

### BRIEF DESCRIPTION OF DRAWINGS

To describe the technical solutions in the embodiments of the present invention more clearly, the following briefly describes the accompanying drawings required for describing the embodiments of the present invention. Apparently, the accompanying drawings in the following description show merely some embodiments of the present invention, and a person of ordinary skill in the art may derive other drawings from these accompanying drawings without creative efforts.

FIG. 1 is a schematic architectural diagram of a communications system according to an embodiment of the present invention;

FIG. 2(a) is a working principle diagram of an OFDM-based transmitter, and FIG. 2(b) is a working principle diagram of an OFDM-based receiver;

FIG. 3 is a frame structure in a TDD standard of an OFDM-based wireless cellular communications system;

FIG. 4 is a schematic block diagram of a data transmission method according to an embodiment of the present invention;

FIG. 5 is a schematic flowchart of a data transmission method according to an embodiment of the present invention;

FIG. 6 is another schematic flowchart of a data transmission method according to an embodiment of the present invention;

FIG. 7 is another schematic block diagram of a data transmission method according to an embodiment of the present invention;

FIG. 8 is a schematic block diagram of a data transmission apparatus according to an embodiment of the present invention;

FIG. 9 is another schematic block diagram of a data transmission apparatus according to an embodiment of the present invention;

FIG. 10 is still another schematic block diagram of a data transmission apparatus according to an embodiment of the present invention; and

FIG. 11 is still another schematic block diagram of a data transmission apparatus according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

It should be understood that the technical solutions of the embodiments of the present invention may be applied to various communications systems, for example, a Global System for Mobile Communications (GSM) system, a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, or a future 5G system.

In particular, the technical solutions of the embodiments of the present invention may be applied to various communications systems based on a non-orthogonal multiple access technology, for example, a sparse code multiple access (SCMA) system and a low density signature (LDS) system. Certainly, the SCMA system and the LDS system may alternatively be called other names in the communications field. Further, the technical solutions of the embodiments of the present invention may be applied to a multi-carrier transmission system using the non-orthogonal multiple access technology, for example, a system that uses orthogonal frequency division multiplexing (OFDM) of the non-orthogonal multiple access technology, filter bank multicarrier (FBMC), generalized frequency division multiplexing (GFDM), or filtered orthogonal frequency division multiplexing (F-OFDM).

It should also be understood that in the embodiments of the present invention, a terminal device may communicate with one or more core networks by using a radio access network (RAN). The terminal device may be referred to as an access terminal, user equipment (UE), a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, an in-vehicle device, a wearable device, or a terminal device in a future 5G network.

It should also be understood that in the embodiments of the present invention, a network device may be configured to communicate with the terminal device. The network device may be a base transceiver station (BTS) in a Global System for Mobile Communications (GSM) system or Code Division Multiple Access (CDMA), may be a NodeB (NB) in a Wideband Code Division Multiple Access (WCDMA) system, or may be an evolved NodeB (eNB or eNodeB) in a Long Term Evolution (LTE) system. Alternatively, the network device may be a relay station, an access point, an in-vehicle device, a wearable device, a base station device in a future 5G (5th-Generation) network, or the like.

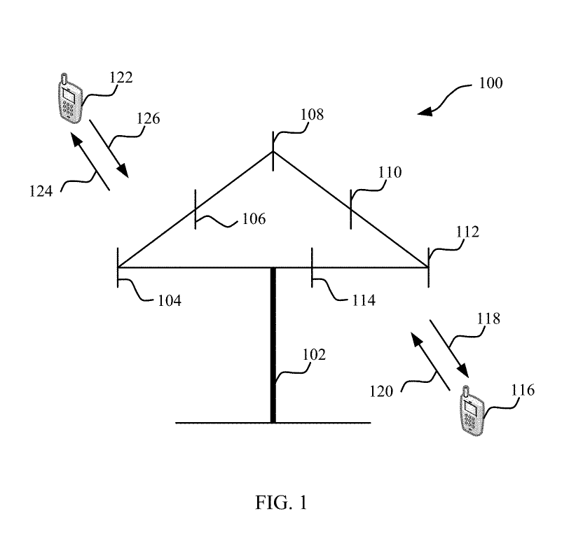

FIG. 1 shows a schematic architectural diagram of a communications system to which an embodiment of the present invention is applied. As shown in FIG. 1, the communications system 100 may include a network device 102. The network device 102 may include one or more antenna groups, and each antenna group may include one or more antennas. For example, one antenna group may include antennas 104 and 106, another antenna group may include antennas 108 and 110, and an additional group may include antennas 112 and 114. Although two antennas are shown in FIG. 1 for each antenna group, it should be understood that each antenna group may have more or fewer antennas. The network device 102 may additionally include a transmitter chain and a receiver chain. A person of ordinary skill in the art can understand that both the transmitter chain and the receiver chain may include a plurality of components related to signal transmission and reception (for example, a processor, a modulator, a multiplexer, a demodulator, a demultiplexer, or an antenna).

The network device 102 may communicate with a plurality of terminal devices (such as a terminal device 116 and a terminal device 122). However, it can be understood that the network device 102 may communicate with any quantity of terminal devices similar to the terminal device 116 or 122. The terminal devices 116 and 122 may be, for example, cellular phones, smart phones, portable computers, handheld communications devices, handheld computing devices, satellite radio apparatuses, global positioning systems, PDAs, and/or any other appropriate devices for communication in the wireless communications system 100.

As shown in FIG. 1, the terminal device 116 communicates with the antennas 112 and 114. The antennas 112 and 114 send information to the terminal device 116 by using a forward link 118 and receive information from the terminal device 116 by using a reverse link 120. In addition, the terminal device 122 communicates with the antennas 104 and 106. The antennas 104 and 106 send information to the terminal device 122 by using a forward link 124 and receive information from the terminal device 122 by using a reverse link 126.

For example, in a frequency division duplex (FDD) system, the forward link 118 may use a frequency band different from that of the reverse link 120, and the forward link 124 may use a frequency band different from that of the reverse link 126. For another example, in a time division duplex (TDD) system and a full duplex system, the forward link 118 and the reverse link 120 may use a same frequency band, and the forward link 124 and the reverse link 126 may also use a same frequency band.

Each group of antennas and/or an area that are/is designed for communication is referred to as a sector of the network device 102. For example, the antenna group may be designed to communicate with the terminal device in a sector within a coverage area of the network device 102. In a process in which the network device 102 communicates with the terminal devices 116 and 122 by using the forward links 118 and 124, respectively, a transmit antenna of the network device 102 may use beamforming to improve a signal-to-noise ratio of the forward links 118 and 124. In addition, compared with a manner in which a network device sends signals to all terminal devices of the network device by using a single antenna, a mobile device in a neighboring cell receives less interference when the network device 102 sends signals to the randomly distributed terminal devices 116 and 122 in a related coverage area through beamforming.

At a specified time, the network device 102, the terminal device 116, or the terminal device 122 may be a wireless communications transmit apparatus and/or a wireless communications receive apparatus. When data is to be sent, the wireless communications transmit apparatus may encode the data for transmission. Specifically, the wireless communications transmit apparatus may obtain (for example, generate, receive from another communications apparatus, or store in a memory) a specific quantity of data bits to be sent to the wireless communications receive apparatus through a channel. Such data bits may be included in a transport block (or a plurality of transport blocks) of the data, and the transport block may be segmented into a plurality of code blocks.

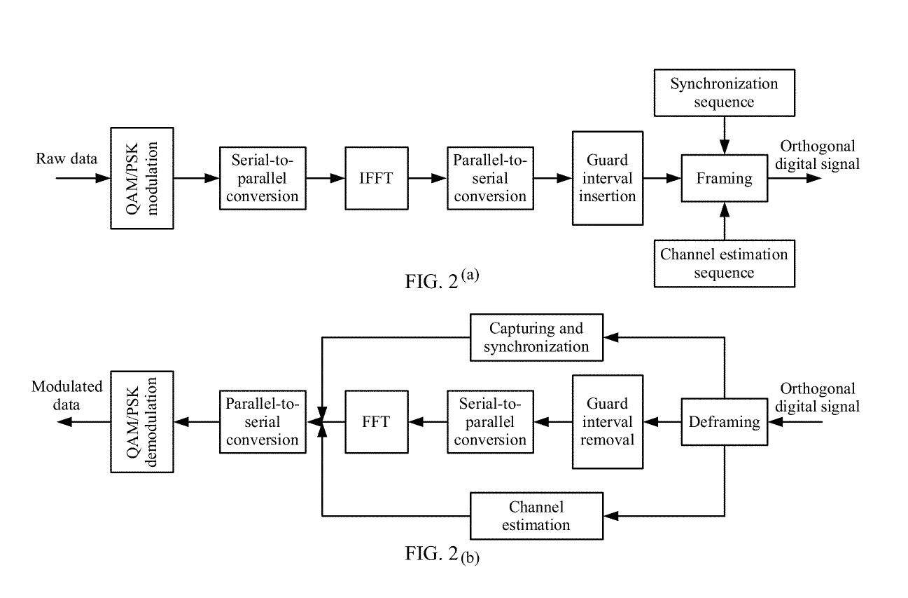

FIG. 1 shows a communications system to which an embodiment of the present invention is applied. The following briefly describes a principle and a basic model of an OFDM system with reference to FIG. 2.

Orthogonal frequency division multiplexing OFDM is a multi-carrier modulation scheme that reduces and eliminates impact of intercode crosstalk, so as to overcome frequency selective fading of a channel. A basic principle of OFDM is to divide a signal into N subsignals, and then modulate N mutually orthogonal subcarriers by using the N subsignals, respectively. Spectrums of subcarriers overlap with each other; therefore, higher spectrum resources can be obtained, and OFDM has been widely applied to the wireless communications field in recent years.

FIG. 2 shows a schematic diagram of OFDM baseband signal processing. FIG. 2(a) is a working principle diagram of a transmitter, and FIG. 2(b) is a working principle diagram of a receiver. A transmit end first performs quadrature amplitude modulation (QAM) or quadrature phase shift keying (QPSK) modulation on a bit stream, then sequentially performs serial-to-parallel transformation and inverse fast Fourier transformation (IFFT) on the bit stream, and then converts parallel data into serial data and adds guard intervals (also referred to as “cyclic prefixes”) to form OFDM code elements. When framing is performed, a synchronization sequence and a channel estimation sequence need to be added, so that a receive end performs burst detection, synchronization, and channel estimation, and finally outputs an orthogonal baseband signal. When detecting arrival of a signal, the receiver first performs synchronization and channel estimation. After time synchronization and fractional frequency offset estimation and correction are completed, fast Fourier transformation (FFT) and integer frequency offset estimation and correction are performed. In this case, obtained data is QAM- or QPSK-modulated data. The data is correspondingly demodulated, to obtain the bit stream.

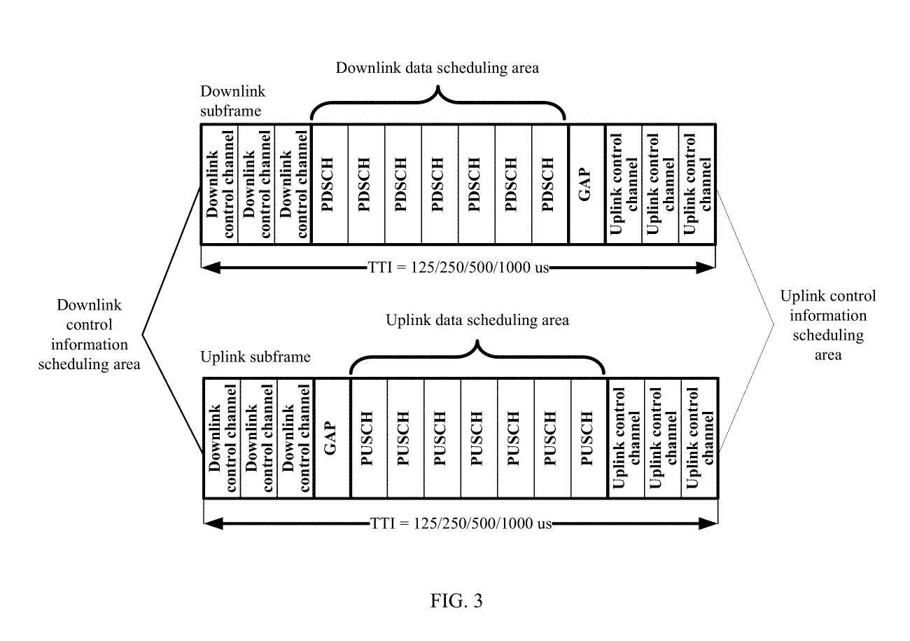

FIG. 3 is a frame structure in a TDD standard of an OFDM-based wireless cellular communications system. A self contained frame structure includes two subframe types: a self contained subframe type 1 (downlink subframe) and a self contained subframe type 2 (uplink subframe). As shown in FIG. 3, the downlink subframe includes the following several parts of content:

a downlink control channel: mainly used to transmit downlink control information (DCI) and acknowledgment feedback information (ACK) of a physical hybrid automatic repeat request indicator channel;

a physical downlink shared channel (PDSCH): mainly used to transmit downlink data;

a gap GAP part: mainly used to reserve a time for switching between uplink and downlink data transmission; and

an uplink control channel: mainly used to transmit uplink control information (UCI) and a sounding reference signal (SRS).

The uplink subframe includes the following several parts of content:

a downlink control channel: mainly used to transmit DCI and a PHICH ACK, where a quantity of symbols occupied by the downlink control channel may be the same as that occupied by the downlink control channel in the downlink subframe;

a gap GAP part: mainly used to reserve a time for switching between uplink and downlink data transmission;

a physical uplink shared channel (PUSCH): mainly used to transmit uplink data; and

an uplink control channel: mainly used to transmit UCI and an SRS, where a quantity of occupied symbols occupied by the uplink control channel may be the same as that occupied by the uplink control channel in the downlink subframe.

Usually, the quantity of OFDM symbols occupied by the downlink control channel and that occupied by the uplink control channel are configurable parameters. For example, in a TDD standard of an LTE system, a physical downlink control channel (PDCCH) usually uses the first one to three OFDM symbols of a subframe to transmit downlink control information. If an excessively small quantity of symbols is configured, when there are a relatively large quantity of UEs in the system, control signaling may be insufficient. If an excessively large quantity of symbols is configured, when there are a relatively small quantity of UEs in the system, a waste of control channel resources may occur. This reduces data transmission efficiency of an Enhanced Mobile Broadband (eMBB) service.

It should be understood that the communications system is a wireless cellular communications system. For example, the system is based on an orthogonal frequency division multiplexing technology. The network device is, for example, a base station. The terminal device is, for example, user equipment. It should be understood that the communications system using the OFDM technology, the base station, and the user equipment are merely used as examples for description in the embodiments of the present invention. The embodiments of the present invention are not limited thereto.

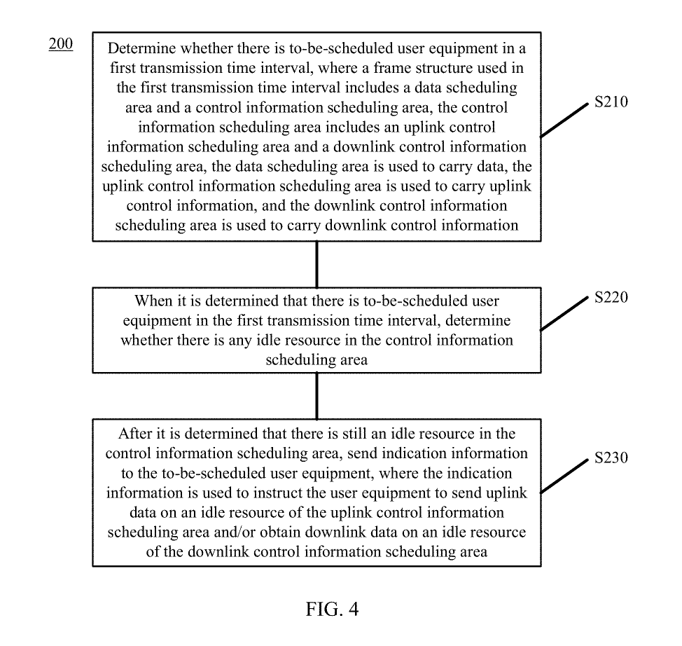

With reference to FIG. 1 to FIG. 3, the foregoing describes an application scenario of the embodiments of the present invention and a frame structure in the OFDM-based TDD standard. The following describes, with reference to FIG. 4 and FIG. 6 and from a perspective of a network side, a data transmission method in the embodiments of the present invention.

FIG. 4 shows a data transmission method 200 according to an embodiment of the present invention. The method 200 may be, for example, executed by a network device. The network device is, for example, a base station. As shown in FIG. 4, the method 200 includes the following steps.

S210: Determine whether there is to-be-scheduled user equipment in a first transmission time interval, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, and the downlink control information scheduling area is used to carry downlink control information.

S220: When it is determined that there is to-be-scheduled user equipment in the first transmission time interval, determine whether there is any idle resource in the control information scheduling area.

S230: After it is determined that there is still an idle resource in the control information scheduling area, send indication information to the to-be-scheduled user equipment, where the indication information is used to instruct the user equipment to send uplink data on an idle resource of the uplink control information scheduling area and/or obtain downlink data on an idle resource of the downlink control information scheduling area.

Specifically, in this embodiment of the present invention, the network device is responsible for managing resource scheduling of uplink and downlink channels, namely, a system resource allocation process, so as to determine at what time which resources may be used by the user equipment to perform data transmission or data reception. When the network device determines that there is to-be-scheduled user equipment within a transmission time interval (TTI), the network device may determine whether there is any idle resource in the control information scheduling area. If there is still an idle resource, the control information scheduling area may be used for data transmission. If there is no idle resource, scheduling in the TTI may be terminated. For example, the network device determines that the to-be-scheduled user equipment needs to transmit uplink data; however, the TTI at this moment happens to be a downlink subframe, that is, the data scheduling area is a downlink data scheduling area PDSCH. When the network device determines that there is still an idle resource in the uplink control information scheduling area, the idle resource of the uplink control information scheduling area may be used to transmit the uplink data, without a need to wait for a next TTI for transmission. For another example, the network device determines that downlink data needs to be transmitted to the to-be-scheduled user equipment; however, the TTI at this moment happens to be an uplink subframe, that is, the data scheduling area is the uplink data scheduling area PUSCH. When the network device determines that there is still an idle resource in the downlink control information scheduling area, the idle resource of the downlink control information scheduling area may be used to transmit the downlink data, without a need to wait for a next TTI for transmission.

According to the data transmission method provided by this embodiment of the present invention, control channel resources can be effectively utilized and data transmission efficiency can be improved.

It should be understood that in this embodiment of the present invention, the indication information may be downlink control information DCI or may be downlink data. The downlink data has an indication function, and the downlink data may be used to indicate, to the user equipment, which location of the uplink control information scheduling area is for transmitting uplink data and/or which location of the downlink control information scheduling area is for obtaining downlink data. Preferably, the indication information is the downlink control information.

It should also be understood that in this application, the data scheduling area refers to a channel carrying data transmission, and the control information scheduling area refers to a channel carrying control information. For example, as shown in FIG. 3, the downlink data scheduling area may be a PDSCH, the downlink control information scheduling area may be a physical downlink control channel PDCCH (PDCCH), the uplink data scheduling area may be a PUSCH, and the uplink control information scheduling area may be a physical uplink control channel PUCCH (PUCCH).

Downlink/uplink service transmission in an LTE system is based on scheduling of the network device. A basic time unit of scheduling is a subframe, and one subframe includes a plurality time-domain symbols. A specific scheduling procedure is that the network device sends a control channel such as the PDCCH, and the control channel may carry PUSCH or PDSCH scheduling information. The scheduling information includes control information, such as resource allocation information and a modulation and coding scheme. The user equipment receives a downlink data channel or sends an uplink data channel by using the scheduling information obtained through blind detection. For example, the UE usually neither knows a quantity of control channel elements (CCE) currently occupied by the PDCCH and a downlink control information (DCI) format of transmitted information, nor knows a location at which information required by the UE is located. However, the UE knows what information the UE currently wants, for example, the information wanted by the UE in an idle state is a paging message, and the UE wants uplink authorization and the like when there is uplink data waiting to be transmitted. For different wanted information, the UE uses a corresponding radio network temporary identifier (RNTI) to perform cyclic redundancy check with CCE information. If the cyclic redundancy check is successful, the UE knows that the information is required by the UE, and then may further know a corresponding DCI format and a modulation scheme, so as to parse out DCI content.

When the network device allocates a scheduling resource to user equipment, a data channel resource occupied by the user equipment may be calculated, so that a resource used for carrying data may be calculated. Similarly, the network device may also calculate a control channel resource occupied for scheduling the user equipment, so as to calculate a remaining resource of the control channel. If the network device calculates the resource available for carrying data as 0, and the control channel still has a remaining resource, the remaining resource of the control channel may be used for data transmission.

For example, if the frame structure used in the transmission time interval TTI for scheduling by the network device is a downlink subframe structure shown in FIG. 3, that is, the data scheduling area is the downlink data scheduling area PDSCH, when determining that there is downlink data to be transmitted, the network device may first determine whether resources are insufficient in the downlink data scheduling area PDSCH; if the resources are insufficient, the network device may further determine whether there is any idle resource in the downlink control information scheduling area; if there is an idle resource in the downlink control information scheduling area, the network device uses the idle resource of the downlink control information scheduling area to transmit the downlink data. Similarly, if the frame structure used in the transmission time interval TTI for scheduling by the network device is an uplink subframe structure shown in FIG. 3, that is, the data scheduling area is the uplink data scheduling area PUSCH, when determining that there is uplink data to be transmitted, the network device may first determine whether resources are insufficient in the uplink data scheduling area PUSCH; if the resources are insufficient, the network device may further determine whether there is any idle resource in the uplink control information scheduling area; if there is an idle resource in the uplink control information scheduling area, the network device uses the idle resource of the uplink control information scheduling area to transmit the uplink data.

When resources of the data scheduling area are insufficient, using a remaining resource of the control information scheduling area for data transmission avoids a waste of control channel resources and improves data transmission efficiency.

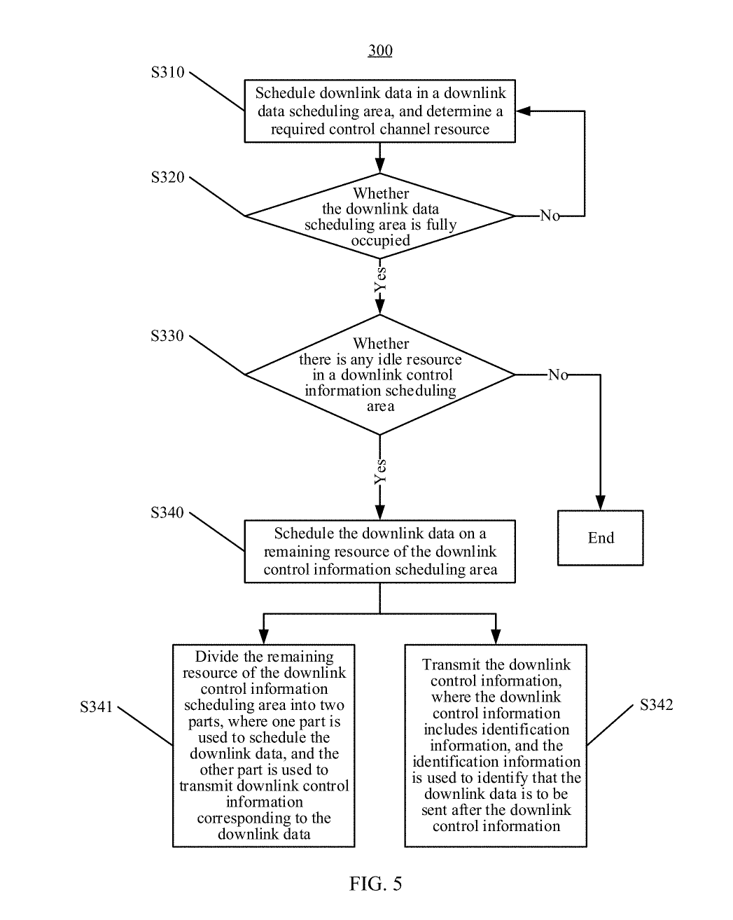

The following provides descriptions by using an example in which the downlink data is transmitted in a downlink subframe. FIG. 5 shows a data transmission method 300 according to an embodiment of the present invention. As shown in FIG. 5, the method 300 includes the following steps.

S310: Schedule downlink data in a downlink data scheduling area, and determine a required control channel resource. A person skilled in the art understands that the downlink data scheduling area refers to a channel resource carrying downlink data, for example, the downlink data scheduling area may be a PDSCH shown in FIG. 3, and the control channel resource may be a PDCCH. Specifically, a base station determines a required PDCCH resource and a physical hybrid automatic repeat request indicator channel (PHICH) resource that is required for (ACK) feedback.

S320: Determine whether the downlink data scheduling area is fully occupied. If the downlink data scheduling area is not fully occupied, S310 is performed; if the downlink data scheduling area is fully occupied, S330 is performed. Specifically, a network device determines a system resource allocation process. To be specific, the network device may know how many resources in the downlink data scheduling area can be used to carry the downlink data. If the network device determines that there is an idle resource in the downlink data scheduling area, when there is still downlink data that needs to be transmitted, the network device continues to use the idle resource in the downlink data scheduling area to transmit the downlink data. If there is no idle resource, that is, the resources of the downlink data scheduling area is fully occupied, S330 is performed.

S330: Determine whether there is any idle resource in a downlink control information scheduling area. If it is determined that the downlink data scheduling area is fully occupied and there is still an idle resource in the downlink control information scheduling area, the downlink data continues to be sent to to-be-scheduled user equipment on the idle resource of the downlink control information scheduling area. If it is determined that the downlink data scheduling area is fully occupied and there is no idle resource in the downlink control information scheduling area, scheduling is terminated, and scheduling is not performed until a next TTI. It should be understood that the to-be-scheduled user equipment may be user equipment whose downlink data has been scheduled, or may be new user equipment whose downlink data has not been scheduled in a cell.

S340: Schedule the downlink data on an idle resource of the downlink control information scheduling area. Specifically, transmission in the downlink control information scheduling area is organized in a form of a CCE. One CCE includes nine resource element groups (REG), and each REG includes four resource elements (RE). Each user equipment may occupy one or more CCE resources.

Optionally, the base station may schedule the downlink data on the idle resource of the downlink control information scheduling area in two manners. S341: The base station may allocate two sets of resources to the to-be-scheduled user equipment; in other words, a remaining resource of a control information scheduling area may be divided into two parts, where one part is used to transmit downlink data for the to-be-scheduled user equipment, and the other part is used to transmit downlink control information corresponding to the downlink data. The downlink control information includes location indication information. Scheduling is successful only when the two sets of resources are successfully allocated at the same time. The user equipment obtains corresponding downlink control information of the user equipment through blind detection, and performs parsing to obtain a location of the downlink data, so that the user equipment can receive the downlink data at the determined location. S342: The base station may allocate one set of resources to the to-be-scheduled user equipment, and may add identification information to downlink control information to be sent by the base station, where the identification information is used to identify that the downlink data is to be sent after the downlink control information. For example, a field may be added to the downlink control information, and the added field is: content flag: 1 bit, where 0 indicates that the downlink control information is merely conventional control information, and 1 indicates that the downlink data follows the downlink control information. It should be understood that scheduling the downlink data by using the remaining resource of the downlink control information scheduling area mentioned in S341 and S342 is merely used as an example for description in this embodiment of the present invention, and this is not limited in the present invention.

A person skilled in the art understands that when receiving the downlink data, the UE needs to obtain, through blind detection, the DCI corresponding to the UE. When performing blind detection in PDCCH search space, the UE merely needs to perform a decoding attempt on DCI that possibly occurs, without a need to perform matching on all DCI formats. A total quantity of PDCCH blind detections performed by the UE does not exceed 44. When the to-be-transmitted downlink data is a small data packet, a manner in the foregoing step S342 is preferably used. The to-be-transmitted downlink data may be disguised as the downlink control information, where the identification information is added to the downlink control information. After receiving the downlink control information, the UE may directly obtain the downlink data through blind detection. However, if to-be-transmitted downlink data is a large data packet, there are a lot of possible results of the blind detection performed by the UE, and therefore, a manner in the foregoing step S341 may be usually used for the large data packet.

It should be understood that the downlink data scheduling area and the downlink control information scheduling area in this application are merely described by using the PDSCH and the PDCCH, respectively, as examples. The present invention is not limited thereto.

The following describes in detail a downlink scheduling process in this embodiment of the present invention. It is assumed that there is only one UE in a cell, and a volume of downlink data required by the UE is relatively large. Firstly, an eNB performs downlink channel quality measurement. The eNB sends a cell feature reference signal to the UE, and the UE estimates and reports a channel quality indication (CQI) to the eNB. The UE reports the CQI in two manners: periodically and aperiodically. The two manners may exist simultaneously. If the two manners are simultaneously used for reporting, periodic reporting is replaced by aperiodic reporting, and the CQI is merely reported aperiodically. The cell feature reference signal is full-band, is for the entire cell, and is sent at a fixed subframe location. The RS signal is referenced whenever the UE needs to report the CQI. The CQI may not only be used to inform the eNB of channel quality, but also include a recommended coding and modulation scheme. Secondly, the eNB allocates a downlink resource. The eNB adaptively allocates a downlink resource based on downlink channel quality, and sends the DCI to the UE by using the PDCCH. Content of the DCI includes resource allocation information, a modulation and coding scheme, and the like. Thirdly, when the eNB determines that the PDSCH channel has no resource and there is still downlink data that needs to be transmitted, the eNB further determines whether the PDCCH channel has an idle resource. Fourthly, when determining that the PDCCH channel still has an idle resource, the eNB divides the PDCCH into two parts, one part is used to transmit remaining downlink data, and the other part is used to transmit downlink control information corresponding to the downlink data. Finally, the UE obtains the downlink control information through blind detection, and receives, according to the downlink control information, the downlink data on the channel resource allocated by eNB.

The foregoing describes in detail downlink data transmission in a downlink subframe, and the following uses uplink data transmission in an uplink subframe as an example for description. FIG. 6 shows a data transmission method 400 according to an embodiment of the present invention. As shown in FIG. 6, the method 400 includes the following steps.

S410: Schedule user equipment to schedule uplink data in an uplink data scheduling area, and determine a required control channel resource. A person skilled in the art understands that the uplink data scheduling area refers to a channel resource carrying uplink data. For example, the uplink data scheduling area may be a PUSCH shown in FIG. 3, and the control channel resource may be a PUCCH. Specifically, a base station schedules user equipment in a cell to perform periodic and/or aperiodic SRS feedback, periodic and/or aperiodic CSI feedback, and periodic scheduling request (SR) feedback, and the base station determines the required control channel resource, including a PUCCH resource and an SRS resource.

S420: Determine whether the uplink data scheduling area is fully occupied. If the uplink data scheduling area is not fully occupied, S410 is performed; if the uplink data scheduling area is fully occupied, S430 is performed. Specifically, a network device determines a system resource allocation process. To be specific, the network device may know how many resources in the uplink data scheduling area can be used to carry uplink data. If the network device determines that there is an idle resource in the uplink data scheduling area, when there is still uplink data that needs to be transmitted, the network device continues to use the idle resource in the uplink data scheduling area to transmit the uplink data. If there is no idle resource, that is, the resources are fully occupied, S430 is performed.

S430: Determine whether there is any idle resource in an uplink control information scheduling area. If it is determined that the uplink data scheduling area is fully occupied and there is still an idle resource in the uplink control information scheduling area, the user equipment may be scheduled to continue to send the uplink data on the idle resource in the uplink control information scheduling area. If it is determined that the uplink data scheduling area is fully occupied and there is no idle resource in the uplink control information scheduling area, scheduling is terminated, and scheduling is not performed until a next TTI. It should be understood that the to-be-scheduled user equipment may be user equipment that has been scheduled, or may be new user equipment that has not been scheduled in the cell.

S440: Send downlink control information to the user equipment, and schedule the user equipment to transmit the uplink data on an idle resource of the uplink control information scheduling area. The downlink control information is used to indicate which uplink control channel resource is used by the user equipment to transmit the uplink data. Specifically, allocation may be performed based on a granularity of the PUCCH resource, so that the idle resource of the uplink control channel scheduling area can be optimally utilized. A person skilled in the art understands that the base station schedules the user equipment to send the uplink data; in other words, before a user sends the uplink data, the base station needs to inform the user equipment of a resource allocation result of the base station, that is, at what time on which carrier by using which modulation and coding scheme the UE may transmit data.

It should be understood that the uplink data scheduling area and the uplink control information scheduling area in this application are merely described by using the PUSCH and the PUCCH, respectively, as examples. The present invention is not limited thereto.

The following describes in detail an uplink scheduling process in this embodiment of the present invention. Firstly, the UE requests an uplink resource from the eNB. According to an upper-layer configuration, the UE transmits an SR by using an uplink control message of the PUCCH based on a specific period and a specific subframe location. To be specific, when the UE needs to send data, the UE sets a corresponding SR to 1, and when there is no resource request, sets the SR to null, instead of using a packet form. The SR is merely responsible for informing the eNB whether there is a resource request, and the eNB is informed of a quantity of specifically required resources through subsequent signaling exchange. Secondly, the eNB performs uplink channel quality measurement. The eNB needs to know the uplink channel quality before allocating the uplink resource to the UE. The eNB allocates a resource to the UE only when the uplink channel quality of the UE is relatively good and there is data that needs to be transmitted. Thirdly, the eNB allocates the resource and informs the UE of an allocation result by using the PDCCH. After allocating the resource, the eNB further needs to inform the UE of the allocation result, that is, at what time on which carrier by using which modulation and coding scheme the UE may transmit data. Fourthly, the UE receives a resource allocation result notification. The UE first receives the resource allocation notification delivered by the eNB and monitors the PDCCH, so as to find a possible uplink transmission resource that is allocated. Fifthly, when the eNB determines that the PUSCH channel has no resource and there is still uplink data that needs to be transmitted, the eNB further determines whether the PUCCH channel has an idle resource. Sixthly, when determining that the PUCCH channel still has an idle resource, the eNB sends the downlink control information to the UE, and schedules the user equipment to transmit the uplink data by using the idle resources of the PUCCH channel. Finally, the UE transmits the uplink data according to the received downlink control information and based on the resources allocated by the eNB.

According to the data transmission method provided by this embodiment of the present invention, when a data scheduling area is fully occupied and there is still data that needs to be transmitted or there is user equipment that needs to be scheduled, a remaining resource of a control information scheduling area is used for data transmission. This avoids a waste of control channel resources and improves data transmission efficiency.

Optionally, a downlink control channel resource occupies three orthogonal frequency division multiplexing OFDM symbols of a frame structure, and/or an uplink control channel resource occupies three orthogonal frequency division multiplexing OFDM symbols of the frame structure. This can further ensure that control channel resources are sufficient and do not become a bottleneck of control information transmission.

Optionally, at least one of the following signaling is carried in the downlink control information scheduling area: a system message broadcast, a random access response (RAR), a paging message paging, and channel state information-reference signal (CSI-RS).

Specifically, in the prior art, upper-layer signaling, such as a system message broadcast, a random access response, and a paging message, is carried in a PDSCH channel, and at least one of the signaling may be sent in a downlink control information scheduling area, or a CSI-RS used for beam tracking and radio resource management (RRM) measurement may be sent in the downlink control information scheduling area, so that scheduling of the upper-layer signaling and the CSI-RS is no longer limited by a ratio of an uplink subframe to a downlink subframe in an original LTE TDD standard. This can implement timely scheduling and transmission and reduce an access delay of the user equipment. The aforementioned signaling is merely an example, and may alternatively be an ultra low delay and ultra reliable machine type communication (UMTC) data packet or the like. This is not limited in the present invention.

It should be understood that carrying important signaling in the downlink control information scheduling area may be sending, before the base station sends the downlink data, the important signaling by using a resource reserved in the downlink control information scheduling area, or may be sending the important signaling by using an idle resource of the downlink control information scheduling area after the downlink data is sent.

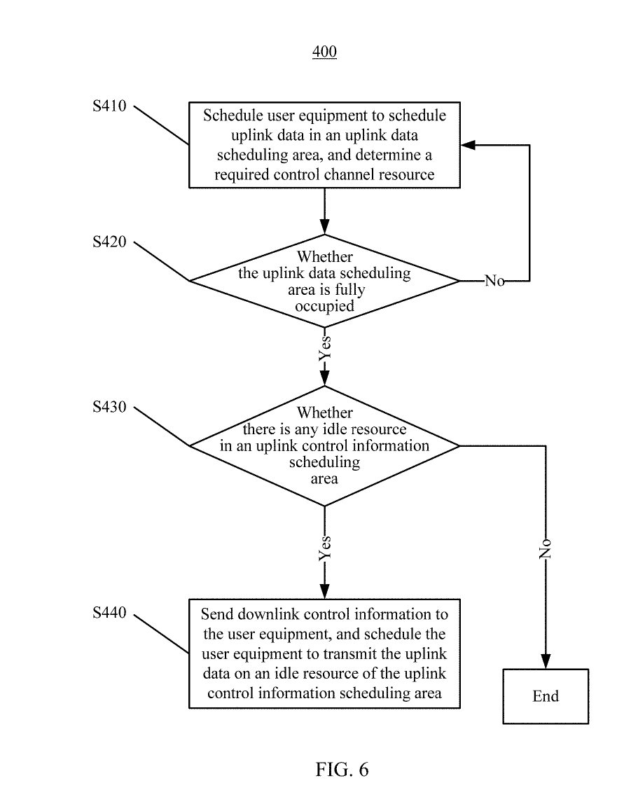

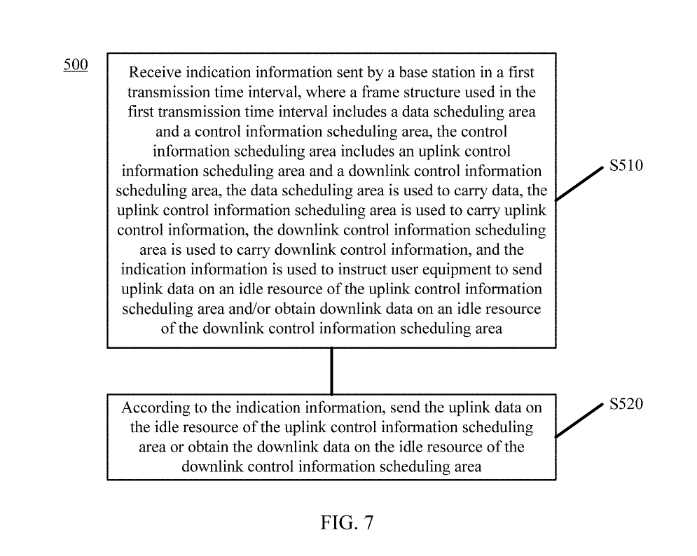

The foregoing describes in detail, with reference to FIG. 3 to FIG. 6 and from a perspective of the network device, the data transmission method in the embodiments of the present invention. The following describes, with reference to FIG. 7 and from a perspective of a terminal device, the data transmission method according to the embodiments of the present invention.

As shown in FIG. 7, a data transmission method 500 according to an embodiment of the present invention may be performed, for example, by a terminal device in a communications system, and the terminal device is, for example, user equipment. As shown in FIG. 7, the method 500 includes the following steps.

S510: Receive indication information sent by a base station in a first transmission time interval, where a frame structure used in the first transmission time interval includes a data scheduling area and a control information scheduling area. The control information scheduling area includes an uplink control information scheduling area and a downlink control information scheduling area, the data scheduling area is used to carry data, the uplink control information scheduling area is used to carry uplink control information, the downlink control information scheduling area is used to carry downlink control information, and the indication information is used to instruct user equipment to send uplink data on an idle resource of the uplink control information scheduling area and/or obtain downlink data on an idle resource of the downlink control information scheduling area.

S520: According to the indication information, send the uplink data on the idle resource of the uplink control information scheduling area or obtain the downlink data on the idle resource of the downlink control information scheduling area.

According to the data transmission method provided by this embodiment of the present invention, control channel resources can be effectively utilized and data transmission efficiency can be improved.

Optionally, the indication information includes location indication information, and the location indication information is used to instruct the user equipment to send the uplink data at a first location of the idle resource of the uplink control information scheduling area and/or receive the downlink data at a second location of the idle resource of the downlink control information scheduling area; and the sending the uplink data on the idle resource of the uplink control information scheduling area and/or obtaining the downlink data on the idle resource of the downlink control information scheduling area includes: according to the indication information, sending the uplink data at the first location and/or receiving the downlink data at the second location.

Optionally, the indication information includes identification information, and the identification information is used to identify that the downlink data is to be transmitted after the indication information, and the sending the uplink data on the idle resource of the uplink control information scheduling area and/or obtaining the downlink data on the idle resource of the downlink control information scheduling area includes: obtaining the downlink data after the indication information according to the identification information.

The identification information is added to the indication information, so that the user equipment can obtain the downlink data through one blind detection.

It should be understood that interaction between the network device and a terminal device, related features and functions, and the like that are described from a perspective of a network device side are corresponding to those described from a perspective of a terminal device side. For brevity, details are not described herein again.

It should also be understood that sequence numbers of the foregoing processes do not mean execution sequences in various embodiments of the present invention. The execution sequences of the processes should be determined based on functions and internal logic of the processes, and should not be construed as any limitation on the implementation processes of the embodiments of the present invention.

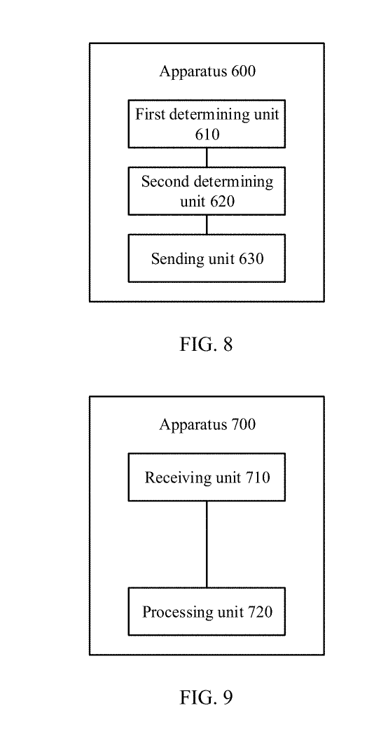

The foregoing describes in detail the data transmission method according to the embodiments of the present invention with reference to FIG. 3 to FIG. 7. The following describes a data transmission apparatus according to the embodiments of the present invention with reference to FIG. 8 to FIG. 11. Technical features described in the method embodiments may be applicable to the following apparatus embodiments.

FIG. 8 shows a data transmission apparatus 600 according to an embodiment of the present invention. As shown in FIG. 8, the apparatus 600 includes:

a first determining unit 610, configured to determine whether there is to-be-scheduled user equipment in a first transmission time interval, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, and the downlink control information scheduling area is used to carry downlink control information;

a second determining unit 620, configured to, when the first determining unit 610 determines that there is to-be-scheduled user equipment in the first transmission time interval, determine whether there is any idle resource in the control information scheduling area; and

a sending unit 630, configured to, after the second determining unit 620 determines that there is still an idle resource in the control information scheduling area, send indication information to the to-be-scheduled user equipment, where the indication information is used to instruct the user equipment to send uplink data on an idle resource of the uplink control information scheduling area and/or obtain downlink data on an idle resource of the downlink control information scheduling area.

Specifically, in this embodiment of the present invention, a network device is responsible for managing resource scheduling of uplink and downlink channels, namely, a system resource allocation process, so as to determine at what time which resources may be used by the user equipment to perform data transmission or data reception. When the network device determines that there is to-be-scheduled user equipment within a transmission time interval (Transmission Time Interval, TTI), the network device may determine whether there is any idle resource in the control information scheduling area. If there is still an idle resource, the control information scheduling area may be used for data transmission. If there is no idle resource, scheduling in the TTI may be terminated. For example, the network device determines that the to-be-scheduled user equipment needs to transmit uplink data; however, the TTI at this moment happens to be a downlink subframe, that is, the data scheduling area is a downlink data scheduling area PDSCH. When the network device determines that there is still an idle resource in the uplink control information scheduling area, the idle resource of the uplink control information scheduling area may be used to transmit the uplink data, without a need to wait for a next TTI for transmission.

According to the data transmission apparatus provided by this embodiment of the present invention, control channel resources can be effectively utilized and data transmission efficiency can be improved.

In this embodiment of the present invention, optionally, the data scheduling area is a downlink data scheduling area, and the second determining unit is specifically configured to determine whether resources are insufficient in the downlink data scheduling area, and when it is determined that the resources are insufficient in the downlink data scheduling area, determine whether there is any idle resource in the downlink control information scheduling area.

In this embodiment of the present invention, optionally, the data scheduling area is an uplink data scheduling area, and the second determining unit is specifically configured to determine whether resources are insufficient in the uplink data scheduling area, and when it is determined that the resources are insufficient in the uplink data scheduling area, determine whether there is any idle resource in the uplink control information scheduling area.

When resources of the data scheduling area are insufficient, using a remaining resource of the control information scheduling area for data transmission avoids a waste of control channel resources and improves data transmission efficiency.

In this embodiment of the present invention, optionally, the indication information includes identification information, and the identification information is used to identify that the downlink data is to be transmitted after the indication information.

In this embodiment of the present invention, optionally, the indication information includes location indication information, and the location indication information is used to instruct the user equipment to send the uplink data at a first location of the idle resource of the uplink control information scheduling area and/or receive the downlink data at a second location of the idle resource of the downlink control information scheduling area.

In this embodiment of the present invention, optionally, at least one of the following signaling is carried in the downlink control information scheduling area: a system message broadcast, a random access response, a paging message, and channel state information-reference signal.

In this embodiment of the present invention, optionally, the apparatus 600 is a network device.

It should be understood that the apparatus 600 according to this embodiment of the present invention may be corresponding to the network device in the method embodiments of the present invention, and the foregoing and other operations and/or functions of each unit in the apparatus 600 are intended to implement corresponding processes of the methods in FIG. 3 to FIG. 6. For brevity, details are not described herein again.

The foregoing describes in detail, with reference to FIG. 8 and from a perspective of a network device side, the data transmission apparatus according to this embodiment of the present invention. The following describes, with reference to FIG. 9 and from a perspective of a terminal device side, a data transmission apparatus according to an embodiments of the present invention. FIG. 9 shows a data transmission apparatus 700 according to an embodiment of the present invention. As shown in FIG. 9, the apparatus 700 includes:

a receiving unit 710, configured to receive indication information sent by a base station in a first transmission time interval, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, the downlink control information scheduling area is used to carry downlink control information, and the indication information is used to instruct user equipment to send uplink data on an idle resource of the uplink control information scheduling area or obtain downlink data on an idle resource of the downlink control information scheduling area; and

a processing unit 720, configured to, according to the indication information received by the receiving unit 710, send the uplink data on the idle resource of the uplink control information scheduling area and/or obtain the downlink data on the idle resource of the downlink control information scheduling area.

In this embodiment of the present invention, optionally, the indication information includes identification information, and the identification information is used to identify that the downlink data is to be transmitted after the indication information, and the processing unit 720 is specifically configured to obtain the downlink data after the indication information according to the identification information.

In this embodiment of the present invention, optionally, the indication information includes location indication information, and the location indication information is used to instruct the user equipment to send the uplink data at a first location of the idle resource of the uplink control information scheduling area and/or receive the downlink data at a second location of the idle resource of the downlink control information scheduling area. The processing unit 720 is specifically configured to, according to the indication information, send the uplink data at the first location and/or receive the downlink data at the second location.

According to the data transmission apparatus provided by this embodiment of the present invention, control channel resources can be effectively utilized and data transmission efficiency can be improved.

In this embodiment of the present invention, optionally, the apparatus 700 is user equipment.

It should be understood that the apparatus 700 for transmitting data and control information according to this embodiment of the present invention may be corresponding to the terminal device in the method embodiments of the present invention, and the foregoing and other operations and/or functions of each unit in the apparatus 700 are intended to implement a corresponding process of the method in FIG. 7. For brevity, details are not described herein again.

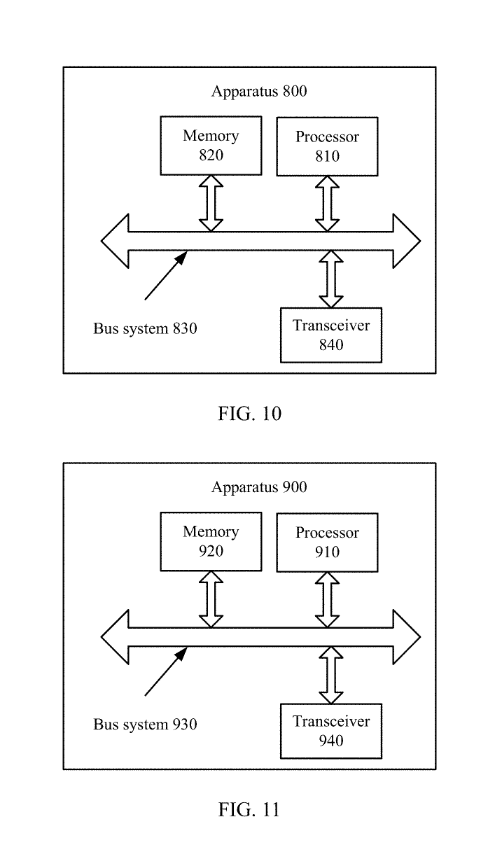

As shown in FIG. 10, an embodiment of the present invention further provides a data transmission apparatus 800. The apparatus 800 includes a processor 810, a memory 820, a bus system 830, and a transceiver 840. The processor 810, the memory 820, and the transceiver 840 are connected by using the bus system 830. The memory 820 is configured to store an instruction, and the processor 810 is configured to execute the instruction stored in the memory 820, to control the transceiver 840 to send a signal. The processor 810 is configured to: determine whether there is to-be-scheduled user equipment in a first transmission time interval, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, and the downlink control information scheduling area is used to carry downlink control information; when it is determined that there is to-be-scheduled user equipment in the first transmission time interval, determine whether there is any idle resource in the control information scheduling area; and after it is determined that there is still an idle resource in the control information scheduling area, send indication information to the to-be-scheduled user equipment, where the indication information is used to instruct the user equipment to send uplink data on an idle resource of the uplink control information scheduling area and/or obtain downlink data on an idle resource of the downlink control information scheduling area.

According to the data transmission apparatus provided by this embodiment of the present invention, control channel resources can be effectively utilized and data transmission efficiency can be improved.

It should be understood that, in this embodiment of the present invention, the processor 810 may be a central processing unit (Central Processing Unit, “CPU” for short), and the processor 810 may alternatively be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be any conventional processor or the like.

The memory 820 may include a read-only memory and a random access memory, and provide an instruction and data for the processor 810. A part of the memory 820 may further include a non-volatile random access memory. For example, the memory 820 may further store device type information.

The bus system 830 may include not only a data bus but also a power bus, a control bus, a status signal bus, and the like. However, for clarity, various types of buses in the figure are all marked as the bus system 830.

In an implementation process, the steps of the foregoing method may be implemented by using an integrated logic circuit of hardware in the processor 810 or by using an instruction in a form of software. The steps of the methods disclosed with reference to the embodiments of the present invention may be directly implemented by a hardware processor, or may be implemented by a combination of hardware in a processor and a software module. The software module may be located in a storage medium that is mature in the art, such as a random access memory, a flash memory, a read-only memory, a programmable read-only memory, an electrically erasable programmable memory, or a register. The storage medium is located in the memory 820, and the processor 810 reads information in the memory 820 and implements, in combination with hardware of the processor, the steps of the foregoing methods. To avoid repetition, details are not described herein again.

It should be understood that the data transmission apparatus 800 according to this embodiment of the present invention may be corresponding to a network device and the apparatus 600 in the embodiments of the present invention, and may also be corresponding to a corresponding execution body of the methods according to the embodiments of the present invention. The foregoing and other operations and/or functions of each unit in the apparatus 800 are intended to implement corresponding processes of the methods in FIG. 3 to FIG. 6. For brevity, details are not described herein again.

As shown in FIG. 11, an embodiment of the present invention further provides a data transmission apparatus 900. The apparatus 900 includes a processor 910, a memory 920, a bus system 930, and a transceiver 940. The processor 910, the memory 920, and the transceiver 940 are connected by using the bus system 930. The memory 920 is configured to store an instruction, and the processor 910 is configured to execute the instruction stored in the memory 920, to control the transceiver 940 to receive a signal. The processor 910 is configured to: receive, in a first transmission time interval, indication information sent by a base station, where a frame structure used in the first transmission time interval includes a data scheduling area and a control information scheduling area, the control information scheduling area includes an uplink control information scheduling area and a downlink control information scheduling area, the data scheduling area is used to carry data, the uplink control information scheduling area is used to carry uplink control information, the downlink control information scheduling area is used to carry downlink control information, and the indication information is used to instruct user equipment to send uplink data on an idle resource of the uplink control information scheduling area and/or obtain downlink data on an idle resource of the downlink control information scheduling area; and according to the indication information, send the uplink data on the idle resource of the uplink control information scheduling area or obtain the downlink data on the idle resource of the downlink control information scheduling area.

According to the data transmission apparatus provided by this embodiment of the present invention, control channel resources can be effectively utilized and data transmission efficiency can be improved.

It should be understood that, in this embodiment of the present invention, the processor 910 may be a central processing unit (CPU), and the processor 910 may alternatively be another general purpose processor, a digital signal processor (DSP), an application-specific integrated circuit (ASIC), a field programmable gate array (FPGA) or another programmable logic device, a discrete gate or transistor logic device, a discrete hardware component, or the like. The general purpose processor may be a microprocessor, or the processor may be any conventional processor or the like.

The memory 920 may include a read-only memory and a random access memory, and provide an instruction and data for the processor 910. A part of the memory 920 may further include a non-volatile random access memory. For example, the memory 920 may further store device type information.

The bus system 930 may include not only a data bus but also a power bus, a control bus, a status signal bus, and the like. However, for clarity, various types of buses in the figure are all marked as the bus system 930.

In an implementation process, the steps of the foregoing method may be implemented by using an integrated logic circuit of hardware in the processor 910 or by using an instruction in a form of software. The steps of the methods disclosed with reference to the embodiments of the present invention may be directly implemented by a hardware processor, or may be implemented by a combination of hardware in a processor and a software module. The software module may be located in a storage medium that is mature in the art, such as a random access memory, a flash memory, a read-only memory, a programmable read-only memory, an electrically erasable programmable memory, or a register. The storage medium is located in the memory 920, and the processor 910 reads information in the memory 920 and implements, in combination with hardware of the processor, the steps of the foregoing methods. To avoid repetition, details are not described herein again.

It should be understood that the data transmission apparatus 900 according to this embodiment of the present invention may be corresponding to a terminal device and the apparatus 700 in the embodiments of the present invention, and may also be corresponding to a corresponding execution body of the methods according to the embodiments of the present invention. The foregoing and other operations and/or functions of each module in the apparatus 900 are intended to implement a corresponding process of the method in FIG. 7. For brevity, details are not described herein again.

In addition, the terms “system” and “network” are usually used interchangeably in this specification. The term “and/or” in this specification describes only an association relationship for describing associated objects and indicates that three relationships may exist. For example, A and/or B may indicate the following three cases: Only A exists, both A and B exist, and only B exists. In addition, the character “/” in this specification usually indicates an “or” relationship between the former and latter associated objects.

It should be understood that in the embodiments of the present invention, “B corresponding to A” indicates that B is associated with A, and B may be determined based on A. However, it should be further understood that determining B based on A does not mean that B is determined based on A only, and B may also be determined based on A and/or other information.

A person of ordinary skill in the art may be aware that, in combination with the examples described in the embodiments disclosed in this specification, units and algorithm steps may be implemented by electronic hardware, computer software, or a combination thereof. To clearly describe interchangeability between the hardware and the software, the foregoing has generally described compositions and steps of each example based on functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for ease and brevity of description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or may be integrated into another system, or some features may be ignored or not performed. In addition, the displayed or discussed mutual couplings, direct couplings, or communication connections may be implemented through some interfaces, or indirect couplings or communication connections between the apparatuses or units, or may be electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected depending on actual requirements, to achieve the objectives of the solutions of the embodiments of the present invention.

In addition, functional units in the embodiments of the present invention may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, a network device, or the like) to perform all or a part of the steps of the methods described in the embodiments of the present invention. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A data transmission method, comprising:
determining whether there is to-be-scheduled user equipment in a first transmission time interval, wherein a frame structure used in the first transmission time interval comprises a data scheduling area and a control information scheduling area, the control information scheduling area comprises an uplink control information scheduling area and a downlink control information scheduling area, the data scheduling area is used to carry data, the uplink control information scheduling area is used to carry uplink control information, and the downlink control information scheduling area is used to carry downlink control information;
when it is determined that there is to-be-scheduled user equipment in the first transmission time interval, determining whether there is any idle resource in the control information scheduling area; and
after it is determined that there is still an idle resource in the control information scheduling area, sending indication information to the to-be-scheduled user equipment, wherein the indication information is used to instruct the user equipment to send uplink data on an idle resource of the uplink control information scheduling area and/or obtain downlink data on an idle resource of the downlink control information scheduling area.

2. The method according to claim 1, wherein the data scheduling area is an uplink data scheduling area, and the determining whether there is any idle resource in the control information scheduling area comprises:
determining whether resources are insufficient in the uplink data scheduling area; and
when it is determined that the resources are insufficient in the uplink data scheduling area, determining whether there is any idle resource in the uplink control information scheduling area.

3. The method according to claim 1, wherein the data scheduling area is a downlink data scheduling area, and the determining whether there is any idle resource in the control information scheduling area comprises:
determining whether resources are insufficient in the downlink data scheduling area; and
when it is determined that the resources are insufficient in the downlink data scheduling area, determining whether there is any idle resource in the downlink control information scheduling area.

4. The method according to claim 1, wherein the indication information comprises location indication information, and the location indication information is used to instruct the user equipment to send the uplink data at a first location of the idle resource of the uplink control information scheduling area and/or receive the downlink data at a second location of the idle resource of the downlink control information scheduling area.

5. The method according to claim 1, wherein the indication information comprises identification information, and the identification information is used to identify that the downlink data is to be transmitted after the indication information.

6. The method according to claim 1, wherein the downlink control information scheduling area comprises a physical downlink control channel (PDCCH), and the PDCCH occupies three orthogonal frequency division multiplexing (OFDM) symbols of the frame structure; and/or the uplink control information scheduling area comprises a physical uplink control channel (PUCCH), and the PUCCH occupies three orthogonal frequency division multiplexing (OFDM) symbols of the frame structure.

7. The method according to claim 1, wherein at least one of the following signaling is carried in the downlink control information scheduling area: a system message broadcast, a random access response, and a paging message.

8. A data transmission method, comprising:
receiving indication information sent by a base station in a first transmission time interval, wherein a frame structure used in the first transmission time interval comprises a data scheduling area, an uplink control information scheduling area, and a downlink control information scheduling area, the data scheduling area is used to carry data, the uplink control information scheduling area is used to carry uplink control information, the downlink control information scheduling area is used to carry downlink control information, and the indication information is used to instruct user equipment to send to-be-transmitted uplink data on an idle resource of the uplink control information scheduling area and/or obtain to-be-transmitted downlink data on an idle resource of the downlink control information scheduling area; and
according to the indication information, sending the uplink data on the idle resource of the uplink control information scheduling area and/or obtaining the downlink data on the idle resource of the downlink control information scheduling area.

9. The method according to claim 8, wherein the indication information comprises identification information, and the identification information is used to identify that the downlink data is to be transmitted after the indication information, and the sending the uplink data on the idle resource of the uplink control information scheduling area and/or obtaining the downlink data from the idle resource of the downlink control information scheduling area comprises:
obtaining the downlink data after the indication information according to the identification information.

10. The method according to claim 8, wherein the indication information comprises location indication information, and the location indication information is used to instruct the user equipment to send the uplink data at a first location of the idle resource of the uplink control information scheduling area and/or receive the downlink data at a second location of the idle resource of the downlink control information scheduling area; and the sending the uplink data on the idle resource of the uplink control information scheduling area and/or obtaining the downlink data on the idle resource of the downlink control information scheduling area comprises:
according to the location indication information, sending the uplink data at the first location and/or receiving the downlink data at the second location.

11. A data transmission apparatus, comprising:
a first determining unit, configured to determine whether there is to-be-scheduled user equipment in a first transmission time interval, wherein a frame structure used in the first transmission time interval comprises a data scheduling area and a control information scheduling area, the control information scheduling area comprises an uplink control information scheduling area and a downlink control information scheduling area, the data scheduling area is used to carry data, the uplink control information scheduling area is used to carry uplink control information, and the downlink control information scheduling area is used to carry downlink control information;
a second determining unit, configured to, when the first determining unit determines that there is to-be-scheduled user equipment in the first transmission time interval, determine whether there is any idle resource in the control information scheduling area; and
a sending unit, configured to, after the second determining unit determines that there is still an idle resource in the control information scheduling area, send indication information to the to-be-scheduled user equipment, wherein the indication information is used to instruct the user equipment to send uplink data on an idle resource of the uplink control information scheduling area and/or obtain downlink data on an idle resource of the downlink control information scheduling area.

12. The apparatus according to claim 11, wherein the data scheduling area is an uplink data scheduling area, and the second determining unit is specifically configured to:
determine whether resources are insufficient in the uplink data scheduling area; and
when it is determined that the resources are insufficient in the uplink data scheduling area, determine whether there is any idle resource in the uplink control information scheduling area.

13. The apparatus according to claim 11, wherein the data scheduling area is a downlink data scheduling area, and the second determining unit is specifically configured to:
determine whether resources are insufficient in the downlink data scheduling area; and
when it is determined that the resources are insufficient in the downlink data scheduling area, determine whether there is any idle resource in the downlink control information scheduling area.

14. The apparatus according to claim 11, wherein the indication information comprises location indication information, and the location indication information is used to instruct the user equipment to send the uplink data at a first location of the idle resource of the uplink control information scheduling area and/or receive the downlink data at a second location of the idle resource of the downlink control information scheduling area.

15. The apparatus according to claim 11, wherein the indication information comprises identification information, and the identification information is used to identify that the downlink data is to be transmitted after the indication information.

16. The apparatus according to claim 11, wherein the downlink control information scheduling area comprises a physical downlink control channel PDCCH, and the PDCCH occupies three orthogonal frequency division multiplexing OFDM symbols of the frame structure; and/or the uplink control information scheduling area comprises a physical uplink control channel PUCCH, and the PUCCH occupies three orthogonal frequency division multiplexing OFDM symbols of the frame structure.

17. The apparatus according to claim 11, wherein at least one of the following signaling is carried in the downlink control information scheduling area: a system message broadcast, a random access response, and a paging message.

18. A data transmission apparatus, comprising:
a receiving unit, configured to receive indication information sent by a base station in a first transmission time interval, wherein a frame structure used in the first transmission time interval comprises a data scheduling area, an uplink control information scheduling area, and a downlink control information scheduling area, the data scheduling area is used to carry data, the uplink control information scheduling area is used to carry uplink control information, the downlink control information scheduling area is used to carry downlink control information, and the indication information is used to instruct user equipment to send to-be-transmitted uplink data on an idle resource of the uplink control information scheduling area and/or obtain to-be-transmitted downlink data on an idle resource of the downlink control information scheduling area; and
an obtaining unit, configured to, according to the indication information, send the uplink data on the idle resource of the uplink control information scheduling area and/or obtain the downlink data on the idle resource of the downlink control information scheduling area.

19. The apparatus according to claim 18, wherein the indication information comprises identification information, and the identification information is used to identify that the downlink data is to be transmitted after the indication information; and the obtaining unit is specifically configured to:
obtain the downlink data after the indication information according to the identification information.

20. The apparatus according to claim 18, wherein the indication information comprises location indication information, and the location indication information is used to instruct the user equipment to send the uplink data at a first location of the idle resource of the uplink control information scheduling area and/or receive the downlink data at a second location of the idle resource of the downlink control information scheduling area; and the obtaining unit is specifically configured to:
according to the location indication information, send the uplink data at the first location and/or receive the downlink data at the second location.
